(19) United States
(12) Patent Application Publication
(10) Pub. No.: US 2006/0224953 A1
(43) Pub. Date: Oct. 5, 2006

(54) Height-width estimation model for a text block

(76) Inventors: Xiaofan Lin, Sunnyvale, CA (US); Charles G. Nelson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/096,579

(22) Filed: Apr. 1, 2005

(51) Int. Cl. G06F 17/00

(52) U.S. Cl. 715/517

(57) ABSTRACT

In a method for establishing a height-width estimation model for a text block, a discrete form of a relationship between the height and the width of the text block is calculated. In addition, at least one coefficient in a polynomial function depicting the relationship between the height and the width is calculated based upon the calculated discrete form and the model is established based upon the calculated at least one coefficient. The model provides a closed form function for estimation of the text block heights associated with one or more widths.

### BACKGROUND

The height-width relationship of text blocks is an important consideration in automatic document layout design. Knowledge of this relationship enables intelligent tradeoffs between horizontal spaces and vertical spaces in documents.

Conventionally, the height-width relationship of text blocks is determined through replacement of the text content in the text blocks under different widths and through a determination of the corresponding heights. This method results in discrete pairs of widths and heights and the results are typically error-free representations of the text block height-width relationships. Although this method provides an accurate relationship between the heights and the widths of the text blocks, implementation of this method typically requires a great deal of time and processing power. For instance, a document containing ten text blocks, each having ten height-width combinations would require the processing of ten to the tenth power of possible combinations. The computation power and time required by processing of this magnitude often exceed practical limits.

Accordingly, it would be desirable to be able to determine the height-width relationships of text blocks in more efficient and less expensive manners.

### SUMMARY

A method for establishing a height-width estimation model for a text block is disclosed herein. In the method, a discrete form of a relationship between the height and the width of the text block is calculated. In addition, at least one coefficient in a polynomial function depicting the relationship between the height and the width is calculated based upon the calculated discrete form and the model is established based upon the calculated at least one coefficient. The model provides a closed form function for estimation of the text block heights associated with one or more widths.

### BRIEF DESCRIPTION OF THE DRAWINGS

Features of the present invention will become apparent to those skilled in the art from the following description with reference to the figures, in which:

FIG. 1A depicts a schematic diagram of a layout that includes various objects positioned at various locations in the layout, according to an embodiment of the invention;

FIG. 1B illustrates a modified version of the layout depicted in FIG. 1A, according to an embodiment of the invention;

FIG. 2 illustrates a block diagram of a layout adjustment system suitable for implementing, either fully or partially, various document layout adjustments and height-width estimation models, according to an embodiment of the invention;

FIG. 3 illustrates a graph of the maximum error results, according to an embodiment of the invention; and

FIG. 4A illustrates a flow diagram of a method for establishing a model for estimating a height-width relationship of text blocks, according to an embodiment of the invention;

FIG. 4B illustrates a flow diagram of a method for adjusting a document layout according to an embodiment of the invention;

FIG. 5 illustrates a flow diagram of a method for establishing a height-width estimation model for a text block, according to an embodiment of the invention; and

FIG. 6 illustrates a computer system, which may be employed to perform various functions described herein, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

As described in greater detail herein below, a method is presented to enable the determination of a closed form model that enables the relatively accurate estimation of text block heights for given widths. The closed form model is in the form of a polynomial function containing one or more coefficients that may be calculated by performing a statistical regression analysis of the relationships based upon the actual heights and the widths of the text blocks. More particularly, in the method, a lookup table is created through actual text placement, using conventional methods. The one or more coefficients in the polynomial function are calculated using statistical regression techniques. In addition, the calculated one or more coefficients may be replaced into the polynomial function to establish the height-width estimation model. The term “polynomial”, as used throughout the present disclosure, may be defined to include a polynomial function of the width “w” and of its reciprocal “1/w”.

Various forms and orders may be used for the statistical regression depending upon, for instance, the actual application scenario. In one regard, the relationships between the heights and the widths of the text blocks may be used as a foundation for simultaneous content adaptation and layout adjustment using, for instance, the Simplex algorithm.

Through implementation of examples of the present invention, a closed mathematical formula is provided to describe the height-width relationship of text blocks. In addition, the accuracy of the estimation may be adjusted by using different terms in the statistical regression. Thus, for instance, adjustments in the layouts of images containing text blocks may be made in a more efficient and less expensive manner as compared with previously known layout adjustment techniques.

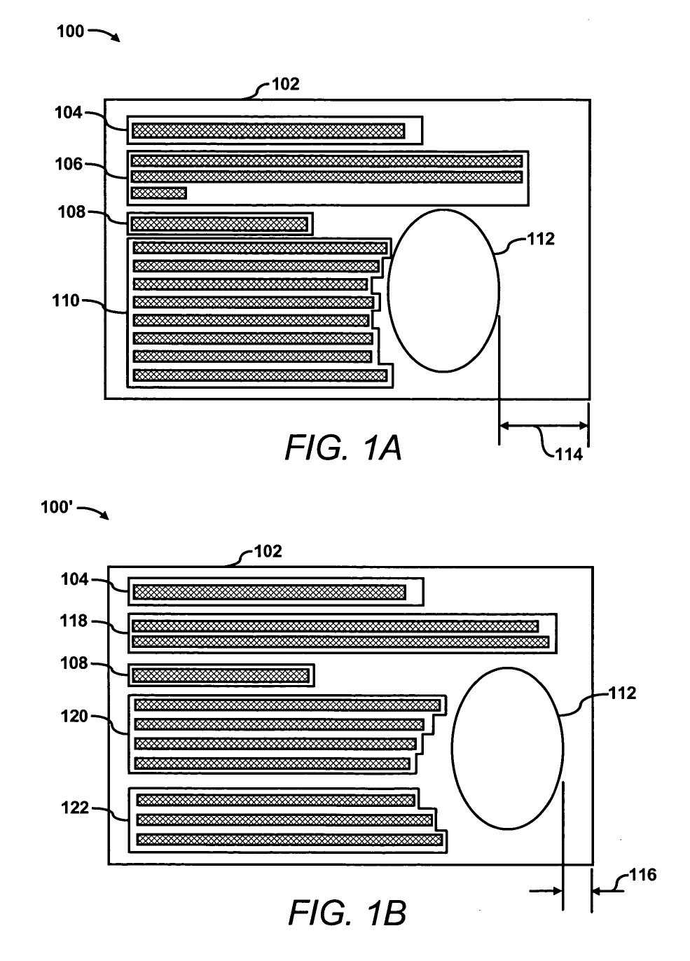

With respect first to FIGS. 1A and 1B, there are shown, respectively, a layout 100 and a modified layout 100′. The layout 100 and the modified layout 100′ are shown to illustrate an example of how a layout 100 may be modified to have the layout illustrated in the modified layout 100′. In the example illustrated in FIGS. 1A and 1B, the layout 100 may be modified to the modified layout 100′ to, for instance, improve the aesthetics of a document 102 containing the layout 100. In other examples, the layout 100 may be modified to adapt the content contained in the layout 100 or for various other reasons, such as, to add, modify, re-position, or remove text or objects.

As shown in FIG. 1A, the layout 100 includes various objects positioned at various locations in the layout 100. The various objects are illustrated as including a number of text blocks 104-110 and an image block 112. Each of the text blocks 104-110 is depicted as including at least one line of text (represented as shaded blocks). In addition, some of the text blocks 104-108 are illustrated as having substantially rectangular shapes; whereas, the text block 110 is illustrated as having a substantially irregular shape corresponding to the actual widths of the lines of the text. As will be described in greater detail herein below, the estimation techniques presented herein are applicable to any of the text blocks 104-110.

The text blocks 104-110 and the image block 112 may be considered as failing to utilize all of the available space in the document 102 to provide an aesthetically pleasing arrangement. For instance, a relatively large space 114 exists between the image block 112 and a right side of the document 102. In addition, the arrangement of objects in the layout 100 generally does not provide a balanced use of horizontal and vertical spaces.

The layout 100 may thus be modified by moving the image block 112 to reduce the size of the space 114 as shown in FIG. 1B. More particularly, FIG. 1B shows a modified layout 100′ of the layout 100 with the image block 112 moved to the right to thereby cause the relatively large space 114 to be reduced to a relatively small space 116. In addition, the relationships between the heights and the widths of some of the text blocks 104-110 have been modified to compensate for the shift in the image block 112 location and to improve the aesthetics of the layout 100.

The text blocks that have been modified are text blocks 106 and 110. The modified version of text block 106 corresponds to text block 118 in FIG. 1B. In addition, the modified version of text block 110 corresponds to text blocks 120 and 122 in FIG. 1B. In comparing the text block 118 from the text block 106, it is evident that the height and the width of the text block 106 have been changed. In addition, the text blocks 120 and 122 have been formed into two separate text blocks from the single text block 110. In this regard, both text blocks 120 and 122 have different heights and widths from the text block 110.

The relationships between the heights and widths of the text blocks 104-110, 118-122 may be determined, for instance, to enable a desirable tradeoff between the horizontal space and the vertical space in the layout 100 to be made. The relationship between the heights and widths of text blocks has typically been determined through an estimation method that actually replaces the text content into various text containers having different widths to determine this relationship. An example of a result of this estimation method is shown in Table 1 below, which illustrates discrete pairs of widths and heights. The relationships between the various heights and widths shown in Table 1 are considered to be “error-free” representations because the relationships are determined through actual text placement into differently sized text blocks.

TABLE 1
Lookup Table for Height-Width Relationship

| | | | | | | | | | | |
|---|---|---|---|---|---|---|---|---|---|---|
| Width | 200 | . . . | 340 | 350 | 360 | 370 | 380 | 390 | . . . | 500 |
| (points) | | | | | | | | | | |
| Height | 41 | . . . | 24 | 23 | 22 | 22 | 21 | 20 | . . . | 16 |
| (lines) | | | | | | | | | | |

Although the relationships denoted in Table 1 may be employed to determine the heights and widths of the modified text blocks 118, 120, and 122, the amount of time and processing power required to determine the values contained in Table 1 for all of the text blocks 118, 120, and 122 may be relatively high. In addition, determination of these values becomes increasingly more difficult as the number of text blocks increases.

As will be described in greater detail herein below, closed formulas are developed to more easily enable estimations of the height-width relationships of text blocks. In one regard, the amount of time and processing power required to determine the height-width relationships of text blocks may substantially be reduced through implementation of the closed formulas disclosed herein. In addition, the closed formulas described herein may enable the use of systematic, numeric optimization-based layout adjustment algorithms, such as, constraint satisfaction solutions.

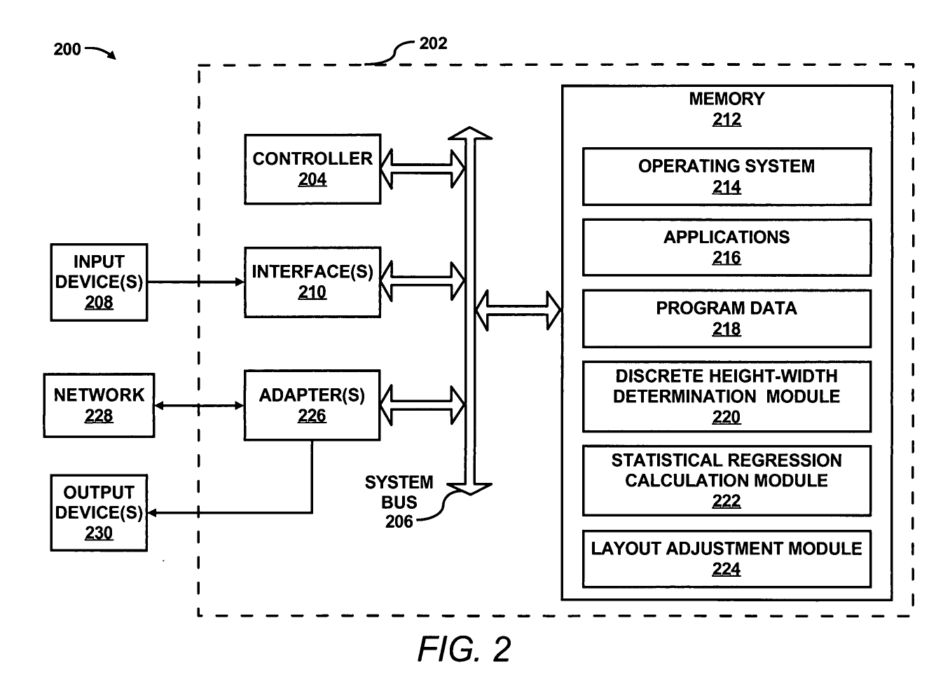

With reference to FIG. 2, there is shown a block diagram 200 of a layout adjustment system 202 suitable for implementing, either fully or partially, various document layout adjustments and height-width estimation models described herein. It should be understood that the following description of the block diagram 200 is but one manner of a variety of different manners in which such a layout adjustment system 202 may be configured or operated. In addition, it should be understood that the layout adjustment system 202 may include additional components and that some of the components described may be removed and/or modified without departing from a scope of the layout adjustment system 202. Although the layout adjustment system 202 is depicted as comprising a computing device, various functions of the layout adjustment system 202 may be performed by various software and/or hardware contained in a computing device. However, the following description of the layout adjustment system 202 is set forth with the layout adjustment system 202 comprising a computing device for purposes of simplicity.

The layout adjustment system 202 may comprise a general computing environment and includes a controller 204 configured to control various operations of the layout adjustment system 202. The controller 204 may comprise a microprocessor, a micro-controller, an application specific integrated circuit (ASIC), and the like. Data may be transmitted to various components of the layout adjustment system 202 over a system bus 206 that operates to couple the various components of the layout adjustment system 202. The system bus 206 represents any of several types of bus structures, including, for instance, a memory bus, a memory controller, a peripheral bus, an accelerated graphics port, a processor bus using any of a variety of bus architectures, and the like.

One or more input devices 208 may be employed to input information into the layout adjustment system 202. The input devices 208 may comprise, for instance, a keyboard, a mouse, a scanner, a disk drive, removable media, flash drives, and the like. The input devices 208 may be used, for instance, to input documents or representations of the documents (that is, the document in code format, which is referred to herein after as a “document” for purposes of simplicity) to the layout adjustment system 202. The input devices 208 are connected to the controller 204 through an interface 210 that is coupled to the system bus 206. The input devices 208 may, however, be coupled by other conventional interface and bus structures, such as, parallel ports, USB ports, etc.

The controller 204 may be connected to a memory 212 through the system bus 206. Generally speaking, the memory 212 may be configured to provide storage of software, algorithms, and the like, that provide the functionality of the layout adjustment system 202. By way of example, the memory 212 may store an operating system 214, application programs 216, program data 218, and the like. In this regard, the memory 212 may be implemented as a combination of volatile and non-volatile memory, such as DRAM, EEPROM, MRAM, flash memory, and the like. In addition, or alternatively, the memory 212 may comprise a device configured to read from and write to a removable media, such as, a floppy disk, a CD-ROM, a DVD-ROM, or other optical or magnetic media.

The memory 212 may also store modules programmed to perform various layout adjustment functions. More particularly, the memory 212 may store a discrete height-width determination module 220, a statistical regression calculation module 222, and a layout adjustment module 224. The discrete height-width determination module 220 generally operates to calculate the discrete form of the height-width relationship of text blocks. The statistical regression calculation module 222 generally operates to run a regression equation to approximate the height of a text block as a polynomial function of the width of the text block based upon the determined discrete height-width relationship.

The controller 204 may implement the discrete height-width determination module 220, more particularly, to determine the discrete relationships of the heights and widths of text blocks through actual text placement. That is, the relationships between the heights and widths of the text blocks contained in a document may be determined through an estimation method that actually replaces the text content into various text containers having different widths to determine the discrete height-width relationship. The output of this estimation method may be used to populate a lookup table, such as Table 1 provided above.

The controller 204 may implement the statistical regression calculation module 222 to calculate a closed formula for the determination of the relationship between various heights and widths of text blocks. More particularly, the statistical regression calculation module 222 may calculate one or more coefficients in the closed formula through statistical regression calculations. Once the coefficients of the closed formula have been calculated, the closed formula may be used to estimate the relationships between the heights and the widths of a text block. In one instance, the height in the closed formula comprises a polynomial function of the width of the text block. For instance, if the text block is rectangular, heuristically, the width (w) and the height (h) should roughly follow a hyperbolic format:
w*h=a, Equation (1)
where “a” is a constant determined by text content, font style, font size, and the actual text placement algorithm. Equation (1) may be rewritten to solve for the height (h) as follows:
h=a/w Equation (2)
However, Equation (2) is considered to be a rough estimate because, extra padding space may be needed for each line, the text lines are discrete in nature (that is, text placement may only generate integer numbers of lines), extra space is wasted at the end of the text block, and there may be other subtle adjustments that may be performed by the text placement algorithm for aesthetic considerations. It has been found that these factors are relatively minor adjustments to the basic form of Equation (2). Therefore, these factors may be treated as terms of different orders and the coefficients (C) may be calculated through regression as described above. Thus, a more generalized form of h(w) is as follows:
h=C0*w+C1+C2/w+C3/(w²). Equation (3)
Although higher order terms may be included in Equation (3), the higher order terms have been omitted because they may be considered as being relatively insignificant. It should, however, be understood that Equation (3) may include the higher order terms without deviating from a scope of the layout adjustment system 202.

In addition, since the height (h) is the number of lines and may only be an integer, a round ( ) function is used to get the nearest integer of h. Thus, the final estimate may be expressed as:
h′=round(h), Equation (4)
which yields the nearest integer of h.

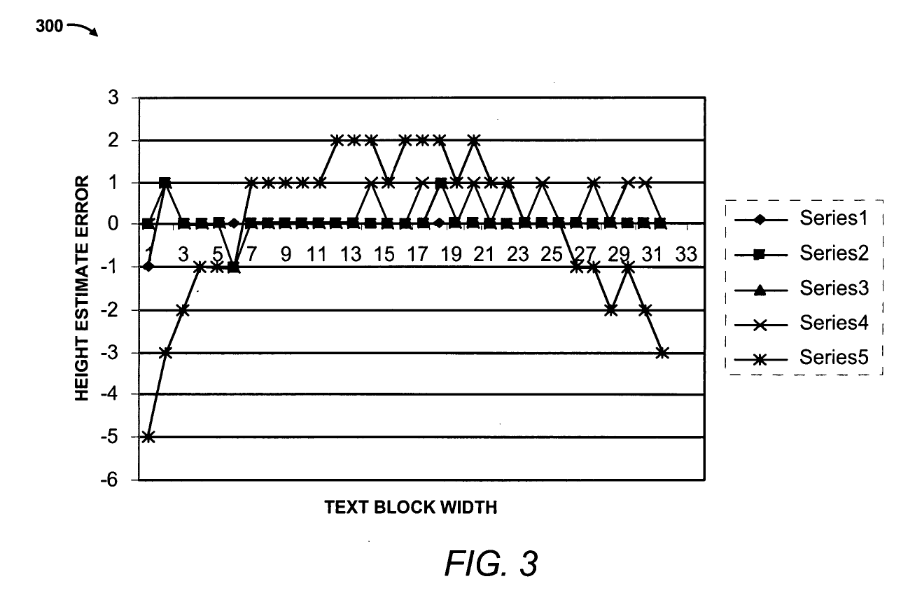

The results of experimental results conducted under five different restriction conditions imposed on the terms in Equation (3) have been listed below in Table 2. In addition, FIG. 3 depicts, in graphical form, the maximum errors obtained in the results listed in Table 2.

TABLE 2
Comparison of different regression models

| | | | | | | | Max |
|---|---|---|---|---|---|---|---|
| Series No | Restrictions | C0 | C1 | C2 | C3 | RMSE | Error |
| 1 | No | 0.01599 | −17.17 | 13551.72 | −531577 | 0.25 | 1 |
| | restrictions | | | | | | |
| 2 | C0 forced | 0 | −1.57 | 8696.07 | −49984.2 | 0.31 | 1 |
| | to 0 | | | | | | |
| 3 | C0, C3 | 0 | −1.04 | 8360.6 | 0 | 0.31 | 1 |
| | forced to 0 | | | | | | |
| 4 | C0, C1, C3 | 0 | 0 | 8120 | 0 | 0.60 | 1 |
| | forced to 0 | | | | | | |
| 5 | C2, C3 | −0.07762 | 51.78 | 0 | 9 | 1.78 | 5 |
| | forced to 0 | | | | | | |

The terms recited in Table 2 were obtained through input of the actual heights and widths from Table 1 into Equation (3) and running a conventional regression method, for instance, through software such as, MATLAB, MS EXCEL, and the like, to obtain the best parameters, which are represented as the terms in Table 2. It should therefore be understood that the values for the coefficients C0-C3 represented in Table 2 are for illustrative purposes and that the coefficients C0-C3 may have other values without deviating from a scope of the layout adjustment system 202. It should also be understood that the values for the coefficients C0-C3 will vary according to the actual relationships between the heights and the widths of the text blocks as set forth, for instance, in Table 1.

As shown in Table 2, the regression method was run without restrictions on the coefficients C0-C3 for the first series. In addition, restrictions were imposed on respective ones of the coefficients C0-C3 in Series 2-5, as noted in the column entitled “Restrictions”. More particularly, in the regression method, one or more of the coefficients C0-C3 were forced to zero and the remaining coefficients C0-C3 were determined. The number of coefficients C0-C3 that are determined generally controls the complexity and accuracy of the regression method. More particularly, the determination of the coefficient C0-C3 values in Series 1 may be considered as being the most complex and the most accurate in terms of the models employed in the Series 1-5.

Table 2 also includes a column entitled “RMSE”, which is an abbreviation for the Root Mean Square Error. The RMSE may generally be determined by calculating the squared deviations of the heights calculated through the regression equations with the actual heights in Table 1, averaging the squares, and taking the square root of the average. As shown in Table 2, the RMSE for the first four series were less than one line. The first model (Series 1) has the lowest RMSE and is therefore the most tunable of the five models. The third model (Series 3) provides the greatest balance between complexity and accuracy of the models. The fifth model (Series 5) has the highest RMSE because it attempts to establish a pure linear relationship (h=C0*w+C1), which, in most cases, does not represent the actual relationships between heights and widths of the text blocks.

However, in certain instance, such as, when adjustments to the layout are relatively minor, the fifth model, which is a linear model, may describe the relationship between the height and the width of a text block with sufficient accuracy. As shown in Table 3, when the degree of adjustment is relatively minor, for instance, below 30%, the max error, which denotes the largest estimation error for any height-width combination used in determining the values of the coefficients C0 and C1, were calculated as being 1 line. More particularly, the max errors were determined by comparing the heights estimated through use of the coefficients C0 and C1 for certain widths with the heights corresponding to the widths listed in Table 1.

As such, for relatively minor layout adjustments, the linear form of Equation (3) may be employed to estimate the heights of various text block widths. In addition, because the linear form may be employed, the conventional Simplex algorithm may be employed to solve a layout adjustment problem in an efficient manner. The layout adjustment problem may be defined as a problem associated with determining a solution layout that satisfies one or more constraints in a layout.

In Table 3, if an application enables the width to change from a minimum width (min_width) to a maximum width (max_width), the degree of adjustment may be defined as:
(max_width−min_width)/(min_width+max_width). Equation (5)

TABLE 3
Accuracy of linear model under different degrees of adjustment

| No | Degree of adjustment | RMSE | C0 | C1 | Max Error |
|---|---|---|---|---|---|
| 1 | 0.43 | 1.78 | −0.0776 | 51.78 | 5 |
| 2 | 0.26 | 0.67 | −0.0704 | 47.97 | 1 |
| 3 | 0.13 | 0.40 | −0.0666 | 46.125 | 1 |

With reference back to Table 2, the column entitled “Max Error” generally denotes the largest estimation error for any height-width combination used in determining the values of the coefficients C0-C3. More particularly, the max errors were determined by comparing the heights estimated through use of the coefficients C0-C3 for certain widths with the heights corresponding to the widths listed in Table 1. The results of the error determinations have been illustrated in the graph 300 depicted in FIG. 3.

As may be seen from the results illustrated in Table 2 and the graph 300, the model represented by Equation (3) may be used as a closed formula to estimate height values for various width values. Therefore, the amount of processing power and time required to estimate the heights corresponding to various widths of text blocks may be significantly lower than is required with known height estimation techniques. In addition, the model represented by Equation (3) may be applied in many instances to non-rectangular and relative short text blocks.

In one regard, the estimation scheme described above may be used by the controller 204 in implementing the layout adjustment module 224. More particularly, for instance, the closed formula of Equation (3) with the coefficients C0-C3 calculated in the manners described above may be employed to determine the height-width relationships of one or more text blocks contained in a document. In addition, these relationships may be used in setting and/or adjusting the layout of text blocks and/or image blocks in the document.

The regression described above may be conducted on a subset or sampling of the height-width combinations contained in Table 1. For instance, the number of height-width combinations used in the regression techniques described above to determine the coefficients C0-C3 may equal to some number less than the entire set of height-width combinations listed in Table 1. However, the number of samples must be at least equal to the number of parameters in the model represented by Equation (3). Through use of the reduced number of samples, the time and computing power required to determine the model represented by Equation (3) may be substantially reduced.

According to another embodiment, parameters for the model may be based upon their physical meanings. For instance, instead of employing statistical regression to experimentally estimate the model parameters (coefficients C0-C3), a more “white-box” approach may be employed. An example of this approach is provided below.

Initially, if a text block width is allowed to be infinite, the text is placed and the occupied length of the text (assigned as “a”) is obtained. Secondly, let “w” be the width of the text and “m” be the number of lines needed for the width. On average, the end of each line will leave an unused space of b/2, where b is the average width of a word. In addition, the end of the last line will leave an unused space of w/2. Based upon these assumptions, a relationship between “a”, “m”, and “w” may be represented as follows:
a=m*w−(m−1)*b/2−w/2. Equation (6)
Multiplying both sides of Equation (6) by 2 yields:
2*a=2*m*w−(m−1)*b−w. Equation (7)
Equation (7) may be re-written as:
2*a=(2*w−b)*m+b−w. Equation (8)
In addition, Equation (8) may be re-written as:
2*a+w−b=(2*w−b)*m. Equation (9)

Equation (9) is equivalent to:
m=(w+2*a−b)/(2*w−b), Equation (10)
which is equivalent to:
=[½+(2*a−b)/(2*w)]/[1−b/(2*w)],
which is approximately equivalent to:
≈[½+(2*a−b)/(2*w)]*[1+b/(2*w)+b*b/(4*w*w)],
which is also approximately equivalent to:
≈½+(a−b/4)/w+(a*b/2−b*b/8)/(w*w),
when w>>b/2.

For purposes of illustration, it is assumed that “a” has been measured to be 7485, and b is 5.6*6.04 (5.6 is assumed to be the average number of characters in a word for that paragraph, and 6.04 is assumed to be the average width of each character for the selected font).

Thus, m may be estimated by:
m=0.5+7476.5/w+126443/(w²). Equation (11)

Application of this model to the data contained in Table 1 results in a Max Error of 1 and a RMSE of 0.43, which may be sufficiently accurate in calculating the height-width relationships.

The height-width relationships of one or more text blocks contained in a document, which may be used in setting and/or adjusting the layout of text blocks and/or image blocks in the document or data pertaining thereto, may be transmitted outside of the layout adjustment system 202 through one or more adapters 226. In a first example, the adjusted layout 100′ data may be transmitted to a network 228, such as, an internal network, an external network (the Internet), etc. In a second example, the adjusted layout 100′ data may be outputted to one or more output devices 230, such as, displays, printers, facsimile machines, etc.

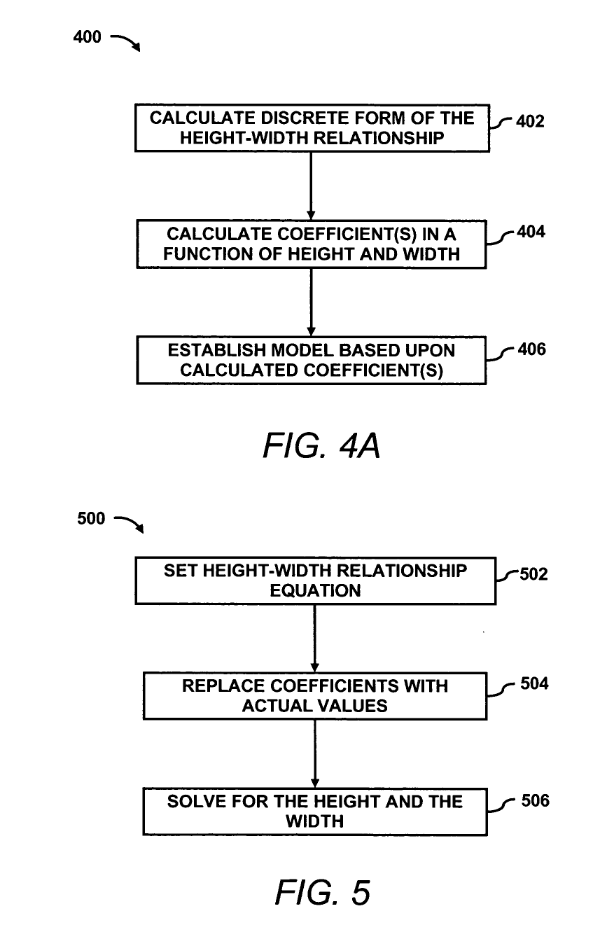

With reference to FIG. 4A, there is shown a flow diagram of a method 400 for establishing a model for estimating a height-width relationship of text blocks. It is to be understood that the following description of the method 400 is but one manner of a variety of different manners in which the model may be established. It should also be apparent to those of ordinary skill in the art that the method 400 represents a generalized illustration and that other steps may be added or existing steps may be removed or modified without departing from a scope of the method 400. The description of the method 400 is made with reference to the block diagram 200 illustrated in FIG. 2, and thus makes reference to the elements cited therein. It should, however, be understood that the method 400 shown in FIG. 4A is not limited to being implemented by the elements shown in FIG. 2 and may be implemented by more, less, or different elements as those shown in FIG. 2.

As shown in FIG. 4A, the discrete form of the height-width relationship for a text block may be calculated as indicated at step 402. The discrete form of the height-width relationship may be calculated through implementation of a conventional actual text placement method, such as, dynamic programming, line-by-line greedy algorithm, or other reasonably suitable and known derivative methods. In any case, the relationships between the height and the width of the text block may be tabulated into a lookup table, for instance, as shown in Table 1 above.

At step 404, one or more of the coefficients in a polynomial function depicting the relationship between the height and the width of a text block may be calculated. As described above, the model may comprise a polynomial function, such as, Equation (3), and the one or more coefficients C0-C3 may be calculated using regression techniques with the discrete heights and widths calculated at step 402. Once the one or more coefficients C0-C3 have been calculated, the values of the coefficients C0-C3 may be put into the model to thereby establish the model as indicated at step 406. In this regard, the model may be established to contain a single unknown, height, for a given width. As such, the model may be implemented to estimate the height associated with a given width for a text block.

With reference now to FIG. 4B, there is shown a flow diagram of a method 420 for adjusting a document layout. It is to be understood that the following description of the method 420 is but one manner of a variety of different manners in which the document layout may be adjusted. It should also be apparent to those of ordinary skill in the art that the method 420 represents a generalized illustration and that other steps may be added or existing steps may be removed or modified without departing from a scope of the method 420. The description of the method 420 is made with reference to the block diagram 200 illustrated in FIG. 2, and thus makes reference to the elements cited therein. It should, however, be understood that the method 420 shown in FIG. 4B is not limited to being implemented by the elements shown in FIG. 2 and may be implemented by more, less, or different elements as those shown in FIG. 2.

The method 420 may be initiated in response to a variety of stimuli at step 422. The method 420 may be initiated, for instance, in response to a command to become initiated by a user, in response to receipt of document layout change request, etc. In any respect, a document may be received at step 424 and at least one text block in the document may be identified at step 426.

At step 428, the discrete form of the height-width relationship of the at least one text block may be calculated. As described above with respect to step 402 (FIG. 4A), the discrete form of the height-width relationship may be calculated through, for instance, implementation of an actual text placement algorithm. In addition, as described above with respect to step 404 (FIG. 4A), one or more of the coefficients in a polynomial function depicting the relationship between the height and the width of a text block may be calculated. The model may comprise a polynomial function, such as, Equation (3), and the one or more coefficients C0-C3 may be calculated using regression techniques with the discrete heights and widths calculated at step 428. Once the one or more coefficients C0-C3 have been calculated, the values of the coefficients C0-C3 may be put into the model to thereby establish the model as indicated at step 432. In this regard, the model may be established to contain a single unknown, height, for a given width.

At step 434, the height of the at least one text block may be estimated through implementation of the model established in step 432. More particularly, the height of the at least one text block may be estimated for one or more widths through use of the model. Knowledge of the estimated heights for various widths may be employed to adjust the layout of the document, as indicated at step 436.

The method 420 may end as indicated at step 438 following adjustment of the document layout. Alternatively, the method 420 may be repeated to adjust the document layout for a number of times or until a desired document layout is reached. In one regard, the desired document layout may comprise a layout in which horizontal and vertical spaces are arranged in an aesthetically pleasing manner.

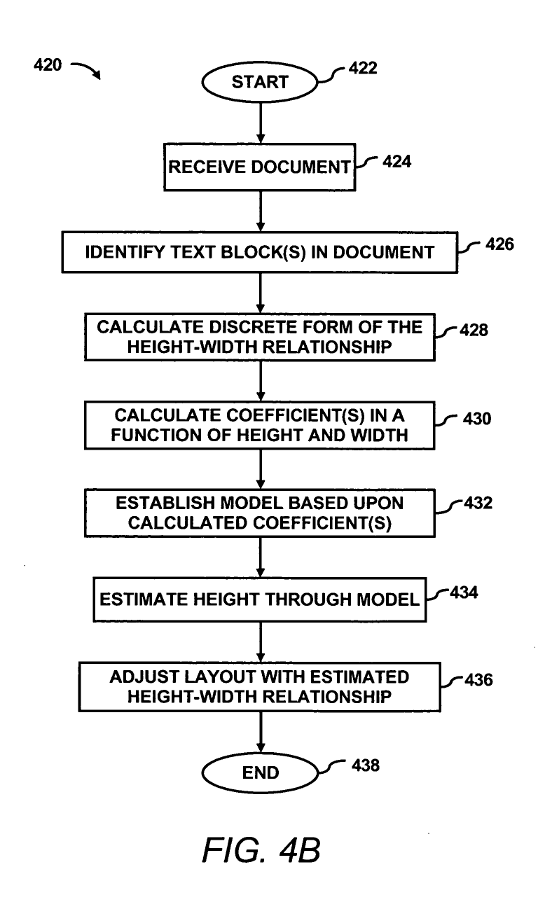

With reference now to FIG. 5, there is shown a flow diagram of a method 500 for establishing a height-width estimation model for a text block. It is to be understood to those of ordinary skill in the art that the method 500 represents a generalized illustration and that other steps may be added or existing steps may be removed or modified without departing from a scope of the method 500.

At step 502, the relationship of the height (m) and the width (w) of a text block may be set according to the following equation:
m=½+(a−b/4)/w+(a*b/2−b*b/8)/(w*w), Equation (12)
where “a” is an occupied length of the text if a text block width is allowed to be infinite, and “b” is the average width of a word in the text block. A manner in which Equation (12) may be derived is described herein above, for instance, as a derivation of Equation (10).

At step 504, the coefficients “a” and “b” may be replaced with their actual values. In addition, at step 506, the height (m) and the width (w) may be solved for to establish the height-width estimation model for the text block.

Through implementation of either of the methods 400, 420, 500 the amount of computing resources required to estimate the heights corresponding to various widths of text blocks may be substantially reduced as compared with traditional methods for estimating these relationships.

Some or all of the operations illustrated in the methods 400, 420, 500 may be contained as a utility, program, or a subprogram, in any desired computer accessible medium. In addition, the methods 400, 420, 500 may be embodied by a computer program, which can exist in a variety of forms both active and inactive. For example, they can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

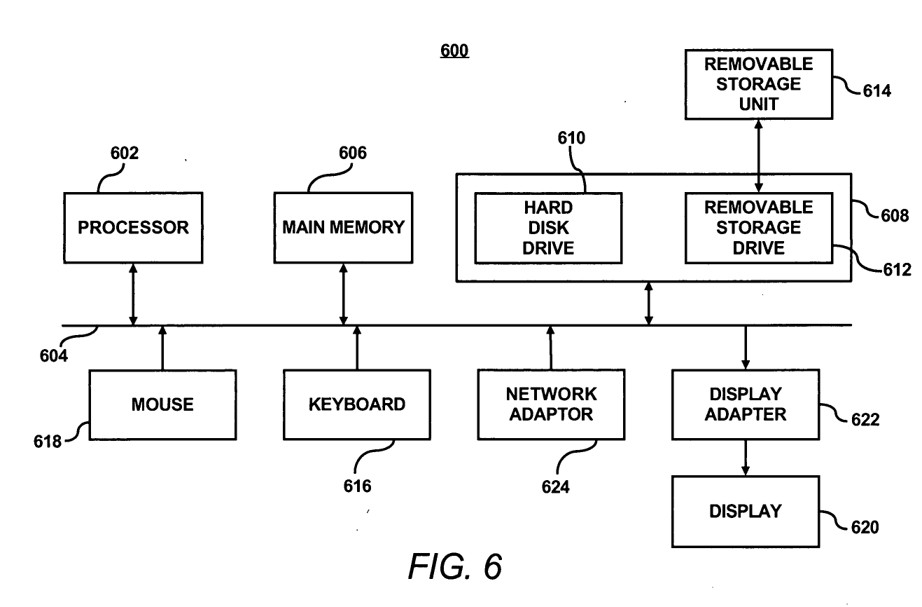

FIG. 6 illustrates a computer system 600, which may be employed to perform various functions described herein. The computer system 600 may include, for example, the controller 204. In this respect, the computer system 600 may be used as a platform for executing one or more of the functions described herein above with respect to the various components of the layout adjustment system 202.

The computer system 600 includes one or more controllers and a processor 602. The processor 602 may be used to execute some or all of the steps described in the methods 400, 420. Commands and data from the processor 602 are communicated over a communication bus 604. The computer system 600 also includes a main memory 606, such as a random access memory (RAM), where the program code for, for instance, the controller 204, may be executed during runtime, and a secondary memory 608. The secondary memory 608 includes, for example, one or more hard disk drives 610 and/or a removable storage drive 612, representing a floppy diskette drive, a magnetic tape drive, a compact disk drive, etc., where a copy of the program code for the layout adjustment system 202 may be stored.

The removable storage drive 610 reads from and/or writes to a removable storage unit 614 in a well-known manner. User input and output devices may include a keyboard 616, a mouse 618, and a display 620. A display adaptor 622 may interface with the communication bus 604 and the display 620 and may receive display data from the processor 602 and convert the display data into display commands for the display 620. In addition, the processor 602 may communicate over a network, for instance, the Internet, LAN, etc., through a network adaptor 624.

It will be apparent to one of ordinary skill in the art that other known electronic components may be added or substituted in the computer system 600. In addition, the computer system 600 may include a system board or blade used in a rack in a data center, a conventional “white box” server or computing device, etc. Also, one or more of the components in FIG. 6 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method for establishing a height-width estimation model for a text block, said method comprising:
calculating a discrete form of a relationship between the height and the width of the text block;
calculating at least one coefficient in a polynomial function depicting the relationship between the height and the width based upon the calculated discrete form; and
establishing the model based upon the calculated at least one coefficient, wherein the model provides a closed form function for estimation of the text block heights associated with one or more widths.

2. The method according to claim 1, wherein the step of calculating at least one coefficient comprises performing a statistical regression to calculate the at least one coefficient in the polynomial function.

3. The method according to claim 1, wherein the step of calculating at least one coefficient comprises calculating at least one coefficient in the following formula:
h=C0*w+C1+C2/w+C3/(w²),
wherein h is the height of a text block, w is the width of the text block, and C0, C1, C2, and C3 are coefficients.

4. The method according to claim 3, wherein the step of establishing the model comprises replacing at least one of the coefficients C0, C1, C2, and C3 with the at least one determined values of the coefficients C0, C1, C2, and C3 in the formula:
h=C0*w+C1+C2/w+C3/(w²).

5. The method according to claim 4, further comprising:
receiving a first width of a text block; and
estimating a value of a first height (h) corresponding to the first width of the text block through use of the formula:
h=C0*w+C1+C2/w+C3/(w²),
wherein the coefficients C0, C1, C2, and C3 comprise the at least one of the determined values of the coefficients C0, C1, C2, and C3.

6. The method according to claim 3, wherein the step of determining values for at least one of the coefficients C0, C1, C2, and C3 comprises imposing a restriction on one or more of the at least one of the coefficients C0, C1, C2, and C3, wherein the restriction comprises forcing the one or more of the at least one of the coefficients to zero.

7. The method according to claim 1, wherein the step of calculating a discrete form of a relationship between the height and the width of the text blocks comprises calculating a plurality of discrete forms of a relationship between the height and the width of the text blocks, and wherein the step of calculating at least one coefficient in a polynomial function comprises calculating the at least one coefficient for less than a total of the plurality of calculated discrete forms.

8. The method according to claim 1, further comprising:
estimating the height of another text block through implementation of the established model.

9. The method according to claim 8, further comprising:
adjusting a layout of a document based upon the estimated height of the another text block.

10. A system for establishing a closed form height-width estimation model for a text block, said system comprising:
a controller configured to determine a discrete height-width relationship of the text block, said controller being further configured to calculate at least one coefficient in a polynomial function depicting the relationship between the height and the width, wherein the controller is configured to use the calculated discrete form of the height-width relationship to calculate the at least one coefficient, and wherein the controller is configured to establish the closed form height-width estimation model based upon the calculated at least one coefficient.

11. The system according to claim 10, wherein the polynomial function comprises the following equation:
h=C0*w+C1+C2/w+C3/(w²),
wherein h is the height of a text block, w is the width of the text block, and C0, C1, C2, and C3 are coefficients, and wherein the controller is configured to perform a statistical regression to calculate at least one of the coefficients for the calculated discrete form of the height and width.

12. The system according to claim 11, wherein the controller is configured to perform the statistical regression with at least one of the coefficients forced to zero.

13. The system according to claim 11, wherein the controller is configured to perform the statistical regression with less than a total of the plurality of calculated discrete forms.

14. The system according to claim 11, wherein the controller is configured to replace the determined values of the coefficients into the polynomial function to establish the height-width estimation model.

15. The system according to claim 10, wherein the controller is configured to estimate the height of another text block through implementation of the established model.

16. The system according to claim 15, wherein the controller is configured to adjust a layout of a document based upon the estimated height of the another text block.

17. A computer system comprising:
means for calculating a discrete form of a height-width relationship of a text block;
means for calculating at least one coefficient in a polynomial function depicting the relationship between the height and the width based upon the calculated discrete form, wherein the polynomial function comprises h=C0*w+C1+C2/w+C3/(w), wherein h is the height of a text block and w is the width of the text block, and C0, C1, C2, and C3 are coefficients; and
means for establishing a height-width estimation model based upon the calculated at least one coefficient, wherein the height-width estimation model provides a closed form function for estimation of the text block heights associated with one or more widths.

18. The computer system according to claim 17, further comprising:
means for employing the height-width estimation model to estimate the heights of text blocks in a document layout design.

19. A computer readable storage medium on which is embedded one or more computer programs, said one or more computer programs implementing a method for establishing a height-width estimation model for a text block, said one or more computer programs comprising a set of instructions for:
calculating a discrete form of a relationship between the height and the width of the text block;
calculating at least one coefficient in a polynomial function depicting the relationship between the height and the width based upon the calculated discrete form, wherein the polynomial function comprises h=C0*w+C1+C2/w+C3/(w²), wherein h is the height of a text block and w is the width of the text block, and C0, C1, C2, and C3 are coefficients; and
establishing the model based upon the calculated at least one coefficient, wherein the model provides a closed form function for estimation of the text block heights associated with one or more widths.

20. The computer readable storage medium according to claim 19, said one or more computer programs further comprising a set of instructions for:
performing a statistical regression to calculate the at least one coefficient in the polynomial function.

21. A method for establishing a height-width estimation model for a text block, said method comprising:
setting the relationship of the height (m) and the width (w) of the text block according to m=½+(a−b/4)/w+(a*b/2−b*b/8)/(w*w), wherein “a” is an occupied length of the text if a text block width is allowed to be infinite, and “b” is the average width of a word in the text block;
replacing “a” and “b” with actual values; and
solving for the height (m) and the width (w) to establish the height-width estimation model for the text block.
